(19) United States
(12) Patent Application Publication
(10) Pub. No.: US 2009/0040214 A1
(43) Pub. Date: Feb. 12, 2009

(54) SIGNAL PROCESSOR, LIQUID CRYSTAL DISPLAY DEVICE INCLUDING THE SAME, AND METHOD OF DRIVING LIQUID CRYSTAL DISPLAY DEVICE

(76) Inventors: Jong-woung PARK, Seongnam-si (KR); Joo-hyung LEE, Gwacheon-si (KR); Sung-woo LEE, Suwon-si (KR); Kee-han UH, Yongin-si (KR); Byung-ki JEON, Seoul (KR)

Correspondence Address: MACPHERSON KWOK CHEN & HEID LLP, 2033 GATEWAY PLACE, SUITE 400, SAN JOSE, CA, 95110, US

(21) Appl. No.: 12/118,587

(22) Filed: May 9, 2008

(30) Foreign Application Priority Data
Aug. 10, 2007 (KR) 10-2007-0080687

(51) Int. Cl. G09G 5/00; G09G 3/36

(52) U.S. Cl. 345/214; 345/87

(57) ABSTRACT

A liquid crystal display device includes a signal processor using an (n−1)-th conversion signal corresponding to an (n−1)-th raw image signal of an (n−1)-th frame to correct an n-th raw image signal of an n-th frame, and outputting an n-th corrected image signal, the (n−1)-th raw image signal. The n-th raw image signal, and the n-th corrected image signal each have ‘a’ bits and the (n−1)-th conversion signal has ‘b’ bits. The ‘b’ bits is smaller than the ‘a’ bits (a>b). A liquid crystal panel displays an image corresponding to the n-th corrected image signal.

### CROSS REFERENCE TO RELATED APPLICATION

This application claims priority from Korean Patent Application No. 10-2007-0080687 filed on Aug. 10, 2007 in the Korean Intellectual Property Office, the disclosure of which is incorporated herein by reference in its entirety.

### BACKGROUND

The present invention relates to a signal processor, a liquid crystal display device including the same, and a method of driving a liquid crystal display device. For example, the invention relates to a relatively small signal processor, a relatively small liquid crystal display device with a signal processor, and a method of driving a liquid crystal display device. The invention may improve display quality.

In general, liquid crystal display (LCD) devices include a first display panel having thin film transistors and pixel electrodes formed thereon, a second display panel having a common electrode formed thereon, and a liquid crystal layer interposed between the first and second display panels. The display quality of the liquid crystal display device is affected by the response speed of liquid crystal. One proposed method of driving LCD devices to increase the response speed includes comparing an image signal of a previous frame with an image signal in the current frame and correcting the image signal of the current frame. This method requires a memory for storing image signals of the previous frame.

However, improvements in display quality have resulted in the number of bits of the image signal of the previous frame increases, which results in an increase in the size of a memory.

### BRIEF SUMMARY

A liquid crystal display device includes a signal processor using an (n−1)-th conversion signal corresponding to an (n−1)-th raw image signal of an (n−1)-th frame to correct an n-th raw image signal of an n-th frame, and outputting an n-th corrected image signal, the (n−1)-th raw image signal. The n-th raw image signal, and the n-th corrected image signal each have ‘a’ bits and the (n−1)-th conversion signal has ‘b’ bits. The ‘b’ bits is smaller than the ‘a’ bits (a>b). A liquid crystal panel displays an image corresponding to the n-th corrected image signal.

In an example embodiment, a liquid crystal display in accordance with the disclosure may have a relatively small size and be capable of improving display quality.

In an example embodiment, a liquid crystal display in accordance with the disclosure may have a relatively small size and may be capable of improving display quality.

In an example embodiment, a method of driving a liquid crystal display device in accordance with the disclosure may be capable of improving display quality.

### BRIEF DESCRIPTION OF THE DRAWINGS

The above and other features and advantages of the present invention will become more apparent by describing in detail preferred embodiments thereof with reference to the attached drawings in which:

FIG. 1 is a block diagram illustrating an example of a liquid crystal display device;

FIG. 2 is an example embodiment of an equivalent circuit diagram of one pixel shown in FIG. 1;

FIG. 3 is a signal diagram illustrating an example embodiment of the operation of the liquid crystal display device shown in FIG. 1;

FIG. 4 is a conceptual diagram illustrating an example embodiment of a signal processor, a liquid crystal display device including the same, and a method of driving a liquid crystal display device;

FIG. 5 is a conceptual diagram illustrating an example embodiment of a signal processor, a liquid crystal display device including the same, and the method of driving a liquid crystal display device;

FIG. 6 is a block diagram illustrating an example embodiment of a signal processor, a liquid crystal display device including the same, and the method of driving a liquid crystal display device;

FIG. 7A is a diagram illustrating an example embodiment of a first look-up table shown in FIG. 6;

FIGS. 7B and 7C are tables illustrating example embodiments of an encoder shown in FIG. 6; and

FIG. 8 is a block diagram illustrating an example embodiment of a signal processor, a liquid crystal display device including the same, and a method of driving a liquid crystal display device.

### DESCRIPTION OF THE PREFERRED EMBODIMENTS

In the following description, a signal processor device may be referred to as a signal processor.

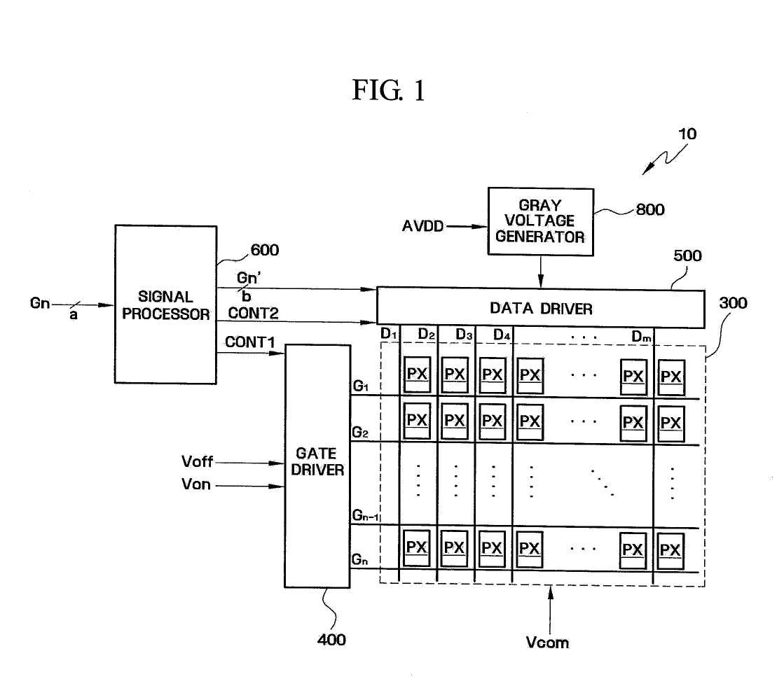

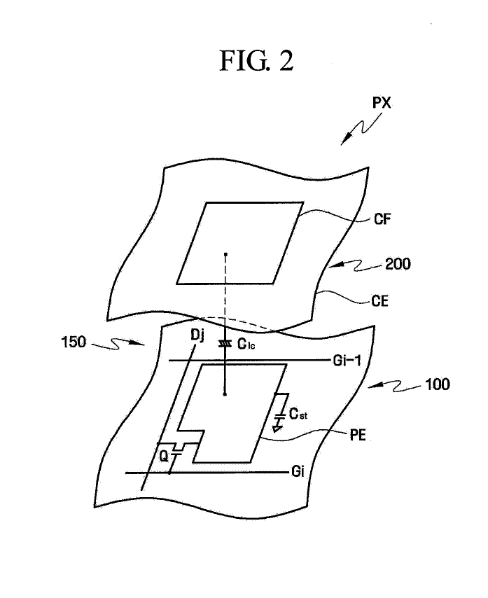

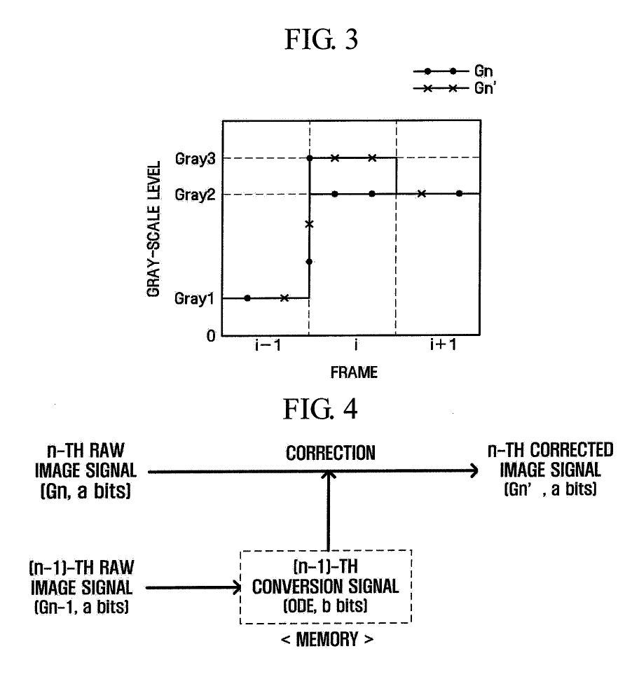

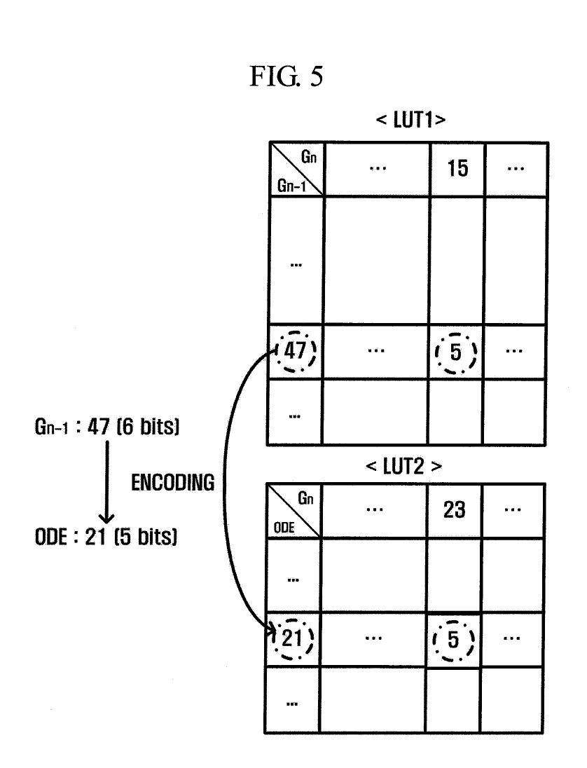

FIGS. 1 through 4 illustrate example embodiments of a signal processor, a liquid crystal display device with a signal processor, and a method of driving the liquid crystal display device according. FIG. 1 is a block diagram illustrating an example embodiment of a liquid crystal display device. FIG. 2 illustrates an example embodiment of an equivalent circuit diagram of one pixel shown in FIG. 1. FIG. 3 is a signal diagram illustrating an example embodiment of the operation of the liquid crystal display device shown in FIG. 1. FIG. 4 is a conceptual diagram illustrating an example embodiment of a signal processor, a liquid crystal display device with a signal processor, and a method of driving the liquid crystal display device.

Referring to FIG. 1, a liquid crystal display device 10 may include a liquid crystal panel assembly 300, a gate driver 400, a data driver 500, and a signal processor 600.

The liquid crystal panel assembly 300 may include a plurality of display signal lines G1 to Gn and D1 to Dm and a plurality of pixels PX that are arranged in a matrix and connected to the display signal lines in an equivalent circuit. Referring to FIG. 2, the liquid crystal panel assembly 300 may include a first display panel 100, a second display panel 200, and a liquid crystal layer 150 interposed between the first and second display panels 100 and 200.

The display signal lines G1 to Gn and D1 to Dm include a plurality of gate lines G1 to Gn for transmitting gate signals and a plurality of data lines D1 to Dm for transmitting data signals. The gate lines G1 to Gn extend substantially in a row direction so as to be parallel to each other, and the data lines D1 to Dm extend substantially in a column direction so as to be parallel to each other.

FIG. 2 shows an example embodiment of an equivalent circuit diagram of one pixel shown in FIG. 1. Color filters CF may be formed in some regions of a common electrode CE formed on the second display panel 200 so as to face corresponding pixel electrodes PE on the first display panel 100. For example, the pixel connected to an i-th (i=1 to n) gate line G1 and a j-th (j=1 to m) data line Dj may include a switching element Q connected to the signal lines G1 and Dj, and a liquid crystal capacitor Clc and a storage capacitor Cst connected to the switching element Q.

In an example embodiment, the gate driver 400 (FIG. 1) may receive a gate control signal CONT1 from the signal processor 600 and supplies gate signals to the gate lines G1 to Gn. The gate signal is composed of a combination of a gate-on voltage Von and a gate-off voltage Voff supplied from a gate on/off voltage generator (not shown). The gate control signal CONT1 may be used to control the operation of the gate driver 500, and may include a vertical start signal for starting the operation of the gate driver 500, a gate clock signal for determining the output timing of the gate-on voltage, and an output enable signal for determining the pulse width of the gate-on voltage.

The data driver 500 may receive a data control signal CONT2 from the signal processor 600 and apply image data voltages to the data lines D1 to Dm. In an example embodiment, the image data voltage is a gray voltage corresponding to an n-th corrected image signal Gn′ output from a gray voltage generator (not shown). The data control signal CONT2 may control the operation of the data driver 400, and may include a horizontal start signal for starting the operation of the data driver 400 and an output instruction signal for instructing the output of a data voltage.

In an example embodiment, the gate driver 400 or the data driver 500 may be directly mounted on the liquid crystal panel assembly 300 in the form of a plurality of driving integrated circuit chips, or it may be mounted on a flexible printed circuit film (not shown) and then adhered to the liquid crystal panel assembly 300 in the form of a tape carrier package. Alternatively, the gate driver 400 or the data driver 500 may be integrated into the liquid crystal panel assembly 300 together with the display signal lines G1 to Gn and D1 to Dm and the switching elements Q, or it may be integrated into a chip together with a signal processor, which will be described later.

In an example embodiment, the signal processor 600 (FIG. 1) may receive an n-th raw image signal Gn of an n-th frame and outputs an n-th corrected image signal Gn′. The signal processor 600 may receive a plurality of clock signals (not shown) required for operations. The n-th raw image signal Gn and the n-th corrected image signal Gn′ are a-bit signals, and the n-th corrected image signal Gn′ may be used to improve the response speed of the liquid crystal. For example, when the n-th raw image signal Gn and the n-th corrected image signal Gn′ each have 64 gray-scale levels, ‘a’ may be 6. In the following description, the n-th raw image signal Gn and the n-th corrected image signal Gn′ each have 64 gray-scale levels, but the invention is not limited thereto.

FIGS. 3 and 4 illustrate example embodiments of the operation of the liquid crystal display device. FIG. 3 illustrates an example embodiment of the gray-scale levels of the n-th raw image signal Gn and the n-th corrected image signal Gn′ of a frame. The gray-scale level of the n-th raw image signal Gn may vary greatly in an i-th frame. That is, the n-th raw image signal Gn may have a first grays-scale level G1 in an (i−1)-th frame, and a second gray-scale level G2 that is higher than the first gray-scale level G1 in the i-th frame and an (i+1)-th frame. The n-th corrected image signal Gn′ may have a gray-scale level higher than the n-th raw image signal Gn in the i-th frame. That is, the n-th corrected image signal Gn′ may have a first gray-scale level G1 and a second gray-scale level G2 in an (i−1)-th frame and an (i+1)-th frame, respectively. In the i-th frame, the n-th corrected image signal Gn′ may have a third gray-scale level G3 that is higher than the second gray-scale level G2.

In the i-th frame, in an example embodiment in which the signal processor 600 supplies the n-th corrected image signal Gn′ having the third gray-scale level G3 that is higher than the second gray-scale level G2, a higher image data voltage may be applied to the liquid crystal capacitor Clc (FIG. 2), as compared to when the n-th raw image signal Gn is supplied. Applying higher image data voltage to the liquid crystal capacitor Clc reduces or shortens the time required for the image data voltage to be charged to the liquid crystal capacitor Clc. That is, as the image data voltage increases, the response speed of the liquid crystal becomes higher, which results in an improvement in display quality.

In an example embodiment, when the n-th raw image signal Gn of the n-th frame has a higher gray-scale level than an (n−1)-th raw image signal Gn−1 of an (n−1)-th frame, the gray-scale level of the n-th corrected image signal Gn′ may be equal to or higher than that of the n-th raw image signal Gn. When the n-th raw image signal Gn has a lower gray-scale level than an (n−1)-th raw image signal Gn−1, the gray-scale level of the n-th corrected image signal Gn′ may be equal to or lower than that of the n-th raw image signal Gn.

In this embodiment, in order to improve the response speed of the liquid crystal in this way, as shown in FIG. 4, an (n−1)-th conversion signal ODE corresponding to the (n−1)-th raw image signal Gn−1 of the (n−1)-th frame may be used to correct the n-th raw image data of the n-th frame, and the n-th corrected image signal Gn′ is output. The (n−1)-th raw image signal Gn−1, the n-th raw image signal Gn, and the n-th corrected image signal Gn′ are a-bit signals, and the (n−1)-th conversion signal ODE is a b-bit signal (a>b).

In an example embodiment, it may be possible to reduce the size of the memory because the memory does not store the a-bit (n−1)-th raw image signal Gn−1, but stores the b-bit (n−1)-th conversion signal ODE. Therefore, it may be possible to reduce the sizes of a signal processor and a liquid crystal display device having a signal processor.

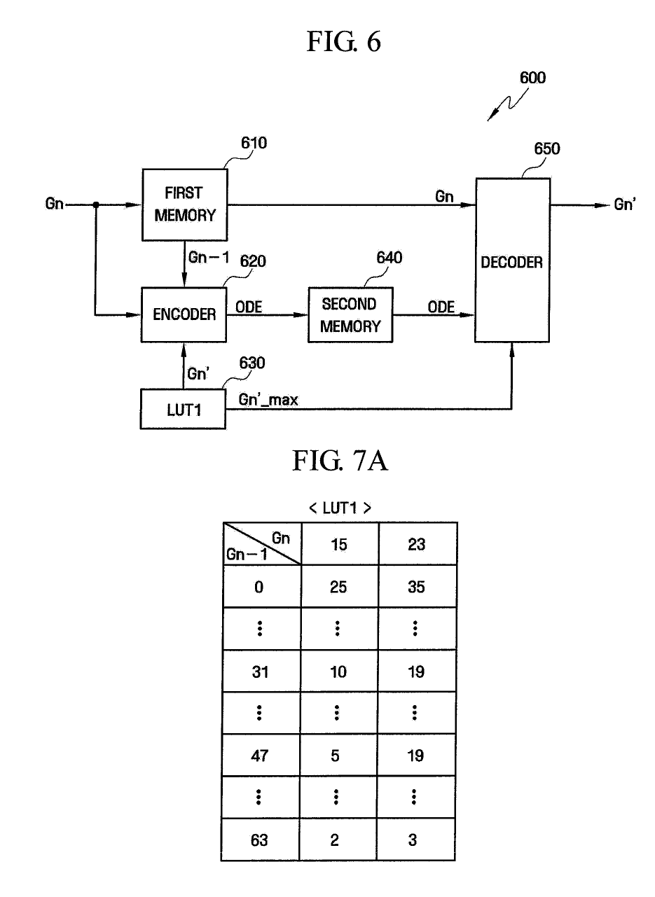

FIGS. 5 through 7B illustrate exemplary embodiments of a signal processor, the liquid crystal display device with a signal processor, and a method of driving the liquid crystal display device.

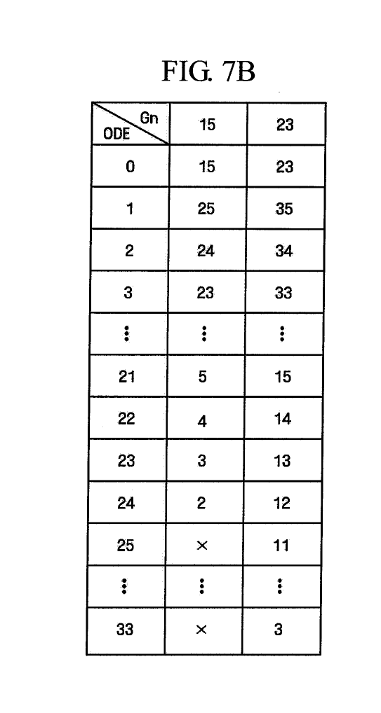

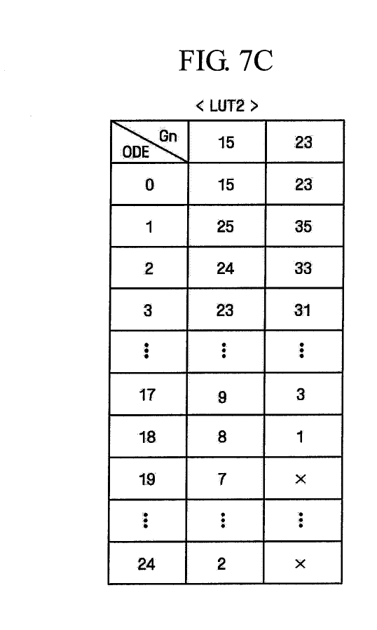

FIG. 5 is a conceptual diagram illustrating an example embodiment of the signal processor, the liquid crystal display device including the same, and the method of driving the liquid crystal display device. FIG. 6 is a block diagram illustrating an example embodiment of the signal processor, the liquid crystal display device including the same, and the method of driving the liquid crystal display device according to the embodiment of the invention. FIG. 7A is a diagram illustrating an example embodiment of the first look-up table shown in FIG. 6. FIGS. 7B and 7C are tables illustrating example embodiments of the encoder shown in FIG. 6.

FIG. 5 illustrates an example embodiment of a first look-up table LUT1 and a second look-up table LUT2. The first look-up table LUT1 shows the gray-scale level of the n-th corrected image signal Gn′ corresponding to the (n−1)-th raw image signal Gn−1 and the n-th raw image signal Gn. For example, when the (n−1)-th raw image signal Gn−1 has a gray-scale level of 47 and the n-th raw image signal Gn has a gray-scale level of 15, the n-th corrected image signal Gn′ has a gray-scale level of 5. The second look-up table LUT2 shows the gray-scale level of the n-th corrected image signal Gn′ corresponding to the (n−1)-th conversion signal ODE and the n-th raw image signal Gn. For example, when the (n−1)-th conversion signal ODE has a gray-scale level of 21 and the n-th raw image signal Gn has a gray-scale level of 15, the n-th corrected image signal Gn′ has a gray-scale level of 5. Since the gray-scale level of the (n−1)-th raw image signal Gn−1 is 47, it is represented by 6 bits in a binary number. Since the (n−1)-th conversion signal ODE has a gray-scale value of 21, it is represented by 5 bits in a binary number.

In this example embodiment, the signal processor 600 encodes the (n−1)-th raw image signal Gn−1 into the (n−1)-th conversion signal ODE, stores the (n−1)-th conversion signal ODE, and uses the (n−1)-th conversion signal ODE to correct the n-th raw image signal Gn. In this case, the signal processor 600 does not store the (n−1)-th raw image signal Gn−1, but stores the (n−1)-th conversion signal ODE which may have fewer bits than those of the (n−1)-th raw image signal Gn−1. It may therefore be possible to reduce the size of an internal memory of the signal processor 600.

Referring to FIG. 6, the signal processor 600 may include a first memory 610, an encoder 620, a first look-up table LUT1, a second memory 640, and a decoder 650. The first look-up table LUT1 may be provided outside the signal processor 600.

The first memory 610 may store the n-th raw image signal Gn, and may output the (n−1)-th raw image signal Gn−1 to the encoder 620. For example, the n-th raw image signal Gn may be stored at an address where the (n−1)-th raw image signal Gn−1 is stored. That is, read and write operations may be continuously performed on one address of the first memory 610.

The first memory 610 may output the n-th raw image signal Gn to the decoder 650. The frequency of the n-th raw image signal Gn input to the signal processor 600 may be different from that of the n-th corrected image signal Gn′ output from the signal processor 600. For example, the n-th corrected image signal Gn′ may be output from the signal processor 600 at a frequency of 60 Hz. The n-th raw image signal Gn may be input to the signal processor 600 at a frequency of, for example, 10 Hz that is lower than 60 Hz. Alternatively, the frequency of the n-th raw image signal Gn input to the signal processor 600 may be variable. That is, the first memory 610 may store the n-th raw image signal Gn that is input at a frequency lower than that at which the n-th corrected image signal Gn′ is output from the signal processor 600. Alternatively, the first memory 610 stores the n-th raw image signal Gn that is input at a variable frequency. After one frame of the n-th raw image signals Gn is stored, the n-th raw image signals Gn may be output to the decoder 650 at a frequency of, for example, 60 Hz.

In an example embodiment, the encoder 620 may encode the (n−1)-th raw image signal Gn−1 into the (n−1)-th conversion signal ODE. That is, the encoder 620 receives the (n−1)-th raw image signal Gn−1 and the n-th raw image signal Gn, and reads out the n-th corrected image signal Gn′ corresponding to the (n−1)-th raw image signal Gn−1 and the n-th raw image signal Gn from the first look-up table LUT1. Then, the encoder 620 may use the read n-th corrected image signal Gn′ to encode the (n−1)-th raw image signal Gn−1 into the (n−1)-th conversion signal ODE. The (n−1)-th raw image signal Gn−1 may have ‘a’ bits, and the (n−1)-th conversion signal ODE may have ‘b’ bits fewer than the ‘a’ bits. The operation of the encoder 620 using the n-th corrected image signal Gn′ to encode the (n−1)-th raw image signal Gn−1 into the (n−1)-th conversion signal ODE is described below with reference to FIGS. 7A to 7C.

In an example embodiment, the second memory 640 stores the b-bit (n−1)-th conversion signal ODE. When the first memory 610 provides the n-th raw image signal Gn to the decoder 650, the second memory 640 provides the (n−1)-th conversion signal ODE to the decoder 650.

The decoder 650 receives the n-th raw image signal Gn and the (n−1)-th conversion signal ODE, and uses the (n−1)-th conversion signal ODE to correct the n-th raw image signal Gn. Then, the decoder 650 outputs the n-th corrected image signal Gn′. The operation of the decoder 650 will be described in detail below.

In an example embodiment as described above, the n-th corrected image signal Gn′ may depend on the n-th raw image signal Gn and the (n−1)-th raw image signal Gn−1 (see FIG. 5). Therefore, it may be possible to reduce the size of an internal memory of the signal processor 600 by using the (n−1)-th conversion signal ODE instead of the (n−1)-th raw image signal Gn−1.

Next, the operation of the encoder 620 will be described in detail with reference to FIGS. 6 to 7C.

In an example embodiment, the encoder 620 may read out the n-th corrected image signal Gn′ corresponding to a pair of the (n−1)-th raw image signal Gn−1 and the n-th raw image signal Gn from the first look-up table LUT1.

FIG. 7A illustrates an example embodiment of the first look-up table LUT1. In FIG. 7A, the n-th raw image signals Gn have gray-scale levels of 15 and 23. Referring to FIG. 7A, when the n-th raw image signal Gn has a gray-scale level of 15 and the (n−1)-th raw image signal Gn−1 has a gray-scale level of 0, the n-th corrected image signal Gn′ has a maximum gray-scale level of 25. When the (n−1)-th raw image signal Gn−1 has a gray-scale level of 63, the n-th corrected image signal Gn′ has a minimum gray-scale level of 2. When the (n−1)-th raw image signal Gn−1 has a gray-scale level that is higher than 0 and lower than 63, the gray-scale level of the n-th corrected image signal Gn′ is lower than 25 and higher than 0.

When the n-th raw image signal Gn has a gray-scale level of 23 and the (n−1)-th raw image signal Gn−1 has a gray-scale level of 0, the n-th corrected image signal Gn′ has a maximum gray-scale level of 35. When the (n−1)-th raw image signal Gn−1 has a gray-scale level of 63, the n-th corrected image signal Gn′ has a minimum gray-scale level of 3. When the (n−1)-th raw image signal Gn−1 has a gray-scale level that is higher than 0 and lower than 63, the n-th corrected image signal Gn′ has a gray-scale level that is lower than 35 and higher than 3.

Referring to FIG. 7B, the gray-scale levels of the n-th corrected image signal Gn′ with respect to the n-th raw image signal Gn are sequentially arrayed. That is, when the n-th raw image signal Gn has a gray-scale level of 15, 24 gray-scale levels from 25 to 2 of the n-th corrected image signal Gn′ are sequentially arrayed. The maximum gray-scale level of 25 corresponds to gray-scale level 1 of the (n−1)-th conversion signal ODE, and the minimum gray-scale level of 2 corresponds to gray-scale level 24 of the (n−1)-th conversion signal ODE. In addition, when the n-th raw image signal Gn has a gray-scale level of 23, 33 gray-scale levels from 35 to 3 of the n-th corrected image signal Gn′ are sequentially arrayed. The maximum gray-scale level of 35 corresponds to gray-scale level 1 of the (n−1)-th conversion signal ODE, and the minimum gray-scale level of 3 corresponds to gray-scale level 33 of the (n−1)-th conversion signal ODE. However, when the (n−1)-th conversion signal ODE has a gray-scale level of 0, the n-th corrected image signal Gn′ and the n-th raw image signal Gn have the same gray-scale level. That is, the encoder 620 uses the following Expression 1 to encode the (n−1)-th raw image signal Gn−1 into the (n−1)-th conversion signal ODE:

ODE=Gn′_max−Gn′+1, [Expression 1]

(where Gn′_max indicates the maximum gray-scale level of the n-th corrected image signal Gn′ with respect to the n-th raw image signal Gn).

For example, when the n-th raw image signal Gn has a gray-scale level of 15 and the (n−1)-th raw image signal Gn−1 has a gray-scale level of 47, the n-th corrected image signal Gn′ has a gray-scale level of 5, as shown in FIG. 7A. According to FIG. 7B and Expression 1, when the n-th raw image signal Gn has a gray-scale level of 15, the encoder encodes the (n−1)-th raw image signal Gn−1 having a gray-scale level of 47 into the (n−1)-th conversion signal ODE having a gray-scale level of 21, in order to make the n-th corrected image signal Gn′ have a gray-scale level of 5.

When the n-th raw image signal Gn has a gray-scale level of 23 and the (n−1)-th raw image signal Gn−1 has a gray-scale level of 47, the n-th corrected image signal Gn′ has a gray-scale level of 13, as shown in FIG. 7A. According to FIG. 7B and Expression 1, when the n-th raw image signal Gn has a gray-scale level of 23, the encoder encodes the (n−1)-th raw image signal Gn−1 having a gray-scale level of 47 into the (n−1)-th conversion signal ODE having a gray-scale level of 23, in order to make the n-th corrected image signal Gn′ have a gray-scale level of 13.

That is, when the n-th raw image signal Gn has a gray-scale level of 15, the encoder 620 provides the (n−1)-th conversion signal ODE having a gray-scale value of 21 to the second memory 640, instead of the (n−1)-th raw image signal Gn−1 having a gray-scale level of 47. Since 47 is 6 bits and 21 is 5 bits when expressed as binary numbers, it may be possible to reduce the size of a memory. In addition, when the n-th raw image signal Gn has a gray-scale level of 23, the encoder 620 provides the (n−1)-th conversion signal ODE having a gray-scale value of 23 to the second memory 640, instead of the (n−1)-th raw image signal Gn−1 having a gray-scale level of 47. Since 47 is 6 bits and 23 is 5 bits when expressed as binary numbers, it may be possible to reduce the size of a memory.

However, in FIG. 7A, when the n-th raw image signal Gn has a gray-scale level of 23 and the (n−1)-th raw image signal Gn−1 has a gray-scale level of 63, the encoder 620 encodes the (n−1)-th raw image signal Gn−1 having a gray-scale level of 63 into the (n−1)-th conversion signal ODE having a gray-scale level of 33. Since 33 is 6 bits when expressed as a binary number, it is difficult to reduce the size of a memory. That is, when the n-th raw image signal Gn has a gray-scale level of 15, the n-th corrected image signal Gn′ has 24 gray-scale levels (see FIG. 7B). Therefore, the (n−1)-th conversion signal ODE corresponding to each of the n-th corrected image signals Gn′ can be represented by 5 bits. However, when the n-th raw image signal Gn has a gray-scale level of 23, the n-th corrected image signal Gn′ has 33 gray-scale levels (see FIG. 7B). Therefore, the (n−1)-th conversion signal ODE cannot be represented by 5 bits.

Therefore, when the n-th raw image signal Gn has a gray-scale level of 23, the encoder 620 encodes the (n−1)-th raw image signal Gn−1 as shown in the second look-up table LUT2 of FIG. 7C. Referring to FIG. 7C, when the (n−1)-th raw image signal Gn−1 has a gray-scale level of 23, unlike when the (n−1)-th raw image signal Gn−1 has a gray-scale level of 15, the gray-scale level of the n-th corrected image signal Gn′ is reduced by 2 as the (n−1)-th conversion signal ODE gradually increases. Therefore, the n-th corrected image signal Gn′ having a minimum gray-scale level of 3 corresponds to the (n−1)-th conversion signal ODE having a gray-scale level of 17. That is, when the n-th raw image signal Gn has a gray-scale level of 23, the encoder 620 encodes the (n−1)-th raw image signal Gn−1 according to Expression 2 given below:

ODE=(Gn′_max−Gn′)/2+1. [Expression 2]

When the n-th raw image signal Gn has a gray-scale level of 23 and the (n−1)-th raw image signal Gn−1 has a gray-scale level of 63, the n-th corrected image signal Gn′ has a gray-scale level of 3, as shown in FIG. 7A. According to FIG. 7C and Expression 2, when the n-th raw image signal Gn has a gray-scale level of 23, the encoder encodes the (n−1)-th raw image signal Gn−1 having a gray-scale level of 63 into the (n−1)-th conversion signal ODE having a gray-scale level of 17 in order to make the n-th corrected image signal Gn′ have a gray-scale level of 3.

Briefly, the encoder 620 encodes the (n−1)-th raw image signal Gn−1 into the (n−1)-th conversion signal ODE, as shown in the second look-up table LUT2. For example, when the (n−1)-th raw image signal Gn−1 has a gray-scale level of 15, the encoder 620 encodes the (n−1)-th raw image signal Gn−1 according to Expression 1. When the (n−1)-th raw image signal Gn−1 has a gray-scale level of 23, the encoder 620 encodes the (n−1)-th raw image signal Gn−1 according to Expression 2.

In order to further reduce the number of bits of the (n−1)-th conversion signal ODE, the encoder may encode the (n−1)-th raw image signal Gn−1 according to Expression 3 given below:

ODE=(Gn′_max−Gn′)/4+1 [Expression 3]

Next, the operation of the decoder 650 receiving the n-th raw image signal Gn and the (n−1)-th conversion signal ODE, correcting the n-th raw image signal Gn, and outputting the n-th corrected image signal Gn′ will be described in detail below.

First, the decoder 650 determines whether the (n−1)-th raw image signal Gn−1 is encoded by any one of Expression 1 to Expression 3 on the basis of the n-th raw image signal Gn. For example, when receiving the n-th raw image signal Gn having a gray-scale level of 15, the decoder 650 determines that the (n−1)-th raw image signal Gn−1 is encoded by Expression 1. When receiving the n-th raw image signal Gn having a gray-scale level of 23, the decoder 650 determines that the (n−1)-th raw image signal Gn−1 is encoded by Expression 2.

When it is determined that the (n−1)-th raw image signal Gn−1 is encoded by Expression 1, the decoder 650 outputs the n-th corrected image signal Gn′ according to Expression 4 given below:

Gn′=Gn′_max−(ODE−1). [Expression 4]

Expression 4 is derived from Expression 1. The decoder 650 may receive the n-th raw image signal Gn and read out the maximum gray-scale level Gn′_max of the n-th corrected image signal Gn′ with respect to the n-th raw image signal Gn from the first look-up table LUT1. Then, the decoder 650 may use the (n−1)-th conversion signal ODE read from the second memory 640 and the maximum gray-scale level Gn′_max read from the first look-up table LUT1 to output the n-th corrected image signal Gn′ according to Expression 4.

When it is determined that the (n−1)-th raw image signal Gn−1 is encoded by Expression 2, the decoder 650 outputs the n-th corrected image signal Gn′ according to Expression 5 given below:

Gn′=Gn′_max−2×(ODE−1). [Expression 5]

Expression 5 is derived from Expression 2.

When it is determined that that (n−1)-th raw image signal Gn−1 is encoded by Expression 3, the decoder 650 outputs the n-th corrected image signal Gn′ according to Expression 6 given below:

Gn′=Gn′_max−4×(ODE−1). [Expression 6]

Expression 6 is derived from Expression 3.

In this way, the decoder 650 outputs the n-th corrected image signal Gn′ according to any one of Expression 4 to Expression 6.

As described above, the decoder 650 may read out the (n−1)-th conversion signal ODE from the second memory 640, and write a value of 0 to the second memory 640. More specifically, as shown in FIG. 3, the signal processor 600 may provide the n-th corrected image signal Gn′ having a higher gray-scale level than that of the n-th raw corrected image signal in an i-th frame, and may provide the n-th corrected image signal Gn′ having the same gray-scale level as that of the n-th raw image signal Gn in an (i+1)-th frame. In order to perform this operation, in the i-th frame, the decoder 650 may readsout the (n−1)-th conversion signal ODE from the memory, output the n-th corrected image signal Gn′, and write a value of 0 to an address where the (n−1)-th conversion signal ODE is stored. In the (i+1)-th frame, the decoder 650 may read out the (n−1)-th conversion signal ODE having a value of 0 from the memory, and may output the n-th raw image signal Gn as the n-th corrected image signal Gn′, as shown in the second look-up table LUT2. In this way, the signal processor 600 may operate as shown in FIG. 3.

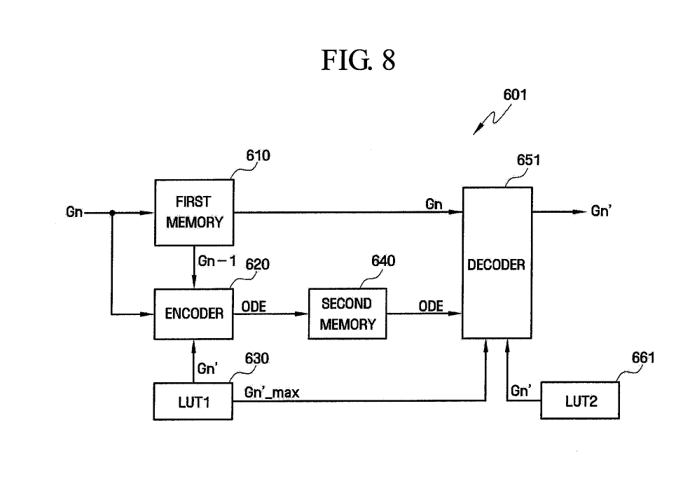

FIG. 8 illustrates a block diagram of an example embodiment of a signal processor, a liquid crystal display device including the same, and a method of driving the liquid crystal display device according to another embodiment of the invention will be described with reference to. In FIG. 8, components having the same functions as those shown in FIG. 6 are denoted by the same reference numerals, and a detailed description thereof is omitted for the convenience of explanation.

In the example embodiment of FIG. 8, a signal processor 601 may further include a second look-up table LUT2. The second look-up table LUT2 may be the same as that shown in FIG. 7C. That is, a decoder 651 may use the n-th raw image signal Gn and the (n−1)-th conversion signal ODE to read out the n-th corrected image signal Gn′ from the second look-up table LUT2, and may output the read signal, without outputting the n-th corrected image signal Gn′ according to Expression 4 to Expression 6. However, the invention is not limited thereto. For example, the second look-up table LUT2 may be provided outside the signal processor 601.

What is claimed is:

1. A liquid crystal display device comprising:
a signal processor using an (n−1)-th conversion signal corresponding to an (n−1)-th raw image signal of an (n−1)-th frame to correct an n-th raw image signal of an n-th frame, and outputting an n-th corrected image signal, the (n−1)-th raw image signal, wherein the n-th raw image signal, and the n-th corrected image signal each have ‘a’ bits and the (n−1)-th conversion signal has ‘b’ bits, wherein the ‘b’ bits is fewer than the ‘a’ bits (a>b); and
a liquid crystal panel displaying an image corresponding to the n-th corrected image signal.

2. The liquid crystal display device of claim 1, further comprising:
a look-up table storing the n-th corrected image signal corresponding to the (n−1)-th raw image signal and the n-th raw image signal,
wherein the signal processor uses the n-th corrected image signal to encode the (n−1)-th raw image signal into the (n−1)-th conversion signal.

3. The liquid crystal display device of claim 1, wherein:
the signal processor comprises:
a first memory for receiving and storing the n-th raw image signal and outputting the (n−1)-th raw image signal;
an encoder for encoding the (n−1)-th raw image signal into the (n−1)-th conversion signal;
a second memory storing the (n−1)-th conversion signal; and
a decoder using the (n−1)-th conversion signal to correct the n-th raw image signal and outputting the n-th corrected image signal.

4. The liquid crystal display device of claim 3, further comprising:
a look-up table storing the n-th corrected image signal corresponding to the (n−1)-th raw image signal and the n-th raw image signal,
wherein the encoder reads out the n-th corrected image signal from the look-up table, and uses the read n-th corrected image signal to encode the (n−1)-th raw image signal into the (n−1)-th conversion signal.

5. The liquid crystal display device of claim 3, further comprising:
a look-up table storing the n-th corrected image signal corresponding to the (n−1)-th conversion signal and the n-th raw image signal,
wherein the decoder reads out the n-th corrected image signal from the look-up table.

6. The liquid crystal display device of claim 1, wherein the frequency of the n-th raw image signal input to the signal processor is different from that of the n-th corrected image signal output from the signal processor.

7. The liquid crystal display device of claim 1, wherein, when a gray-scale level of the n-th raw image signal is higher than a gray-scale level of the (n−1)-th raw image signal, a gray-scale level of the n-th corrected image signal is equal to or higher than that the gray-scale level of the n-th raw image signal.

8. The liquid crystal display device of claim 1, wherein, when a gray-scale level of the n-th raw image signal is lower than a gray-scale level of the (n−1)-th raw image signal, a gray-scale level of the n-th corrected image signal is equal to or lower than that the gray-scale level of the n-th raw image signal.

9. A signal processor comprising:
a first memory for receiving and storing an n-th raw image signal of an n-th frame and outputting an (n−1)-th raw image signal of an (n−1)-th frame;
an encoder for encoding the (n−1)-th raw image signal into an (n−1)-th conversion signal;
a second memory for storing the (n−1)-th conversion signal; and
a decoder for using the (n−1)-th conversion signal and the n-th raw image signal to output an n-th corrected image signal,
wherein the (n−1)-th raw image signal, and the n-th raw image signal, and the n-th corrected image signal each have ‘a’ bits, and
the (n−1)-th conversion signal has ‘b’ bits, wherein the ‘b’ bits is fewer than the ‘a’ bits (a>b).

10. The signal processor of claim 9, further comprising:
a look-up table storing the n-th corrected image signal corresponding to the (n−1)-th raw image signal and the n-th raw image signal,
wherein the encoder reads out the n-th corrected image signal from the look-up table, and uses the read n-th corrected image signal to encode the (n−1)-th raw image signal into the (n−1)-th conversion signal.

11. The signal processor of claim 9, further comprising:
a look-up table storing the n-th corrected image signal corresponding to the (n−1)-th conversion signal and the n-th raw image signal,
wherein the decoder reads out the n-th corrected image signal from the look-up table.

12. The signal processor of claim 9, wherein a frequency of the n-th raw image signal input to the signal processor is different from a frequency of the n-th corrected image signal output from the signal processor.

13. The signal processor of claim 9, wherein, when a gray-scale level of the n-th raw image signal is higher than a gray-scale level of the (n−1)-th raw image signal, a gray-scale level of the n-th corrected image signal is equal to or higher than the gray-scale level of the n-th raw image signal.

14. The signal processor of claim 9, wherein, when a gray-scale level of the n-th raw image signal is lower than a gray-scale level than the (n−1)-th raw image signal, a gray-scale level of the n-th corrected image signal is equal to or lower than of the gray-scale level of the n-th raw image signal.

15. A method of driving a liquid crystal display device, the method comprising:
providing an n-th raw image signal of an n-th frame and providing an (n−1)-th conversion signal corresponding to an (n−1)-th raw image signal of an (n−1)-th frame;
correcting the n-th raw image signal on the basis of the (n−1)-th conversion signal to provide an n-th corrected image signal; and
displaying an image corresponding to the n-th corrected image signal,
wherein the (n−1)-th raw image signal, the n-th raw image signal, and the n-th corrected image signal each have ‘a’ bits, and
the (n−1)-th conversion signal has ‘b’ bits, wherein the ‘b’ bits is fewer than the ‘a’ bits (a>b).

16. The method of claim 15, wherein:
providing the (n−1)-th conversion signal comprises:
encoding the (n−1)-th raw image signal into the (n−1)-th conversion signal using the n-th corrected image signal.

17. The method of claim 15, wherein, when a gray-scale level of the n-th raw image signal is higher than a gray-scale level of the (n−1)-th raw image signal, a gray-scale level of the n-th corrected image signal is equal to or higher than the gray-scale level of the n-th raw image signal.

18. The method of claim 15, wherein, when a gray-scale level of the n-th raw image signal is lower than a gray-scale level of the (n−1)-th raw image signal, a gray-scale level of the n-th corrected image signal is equal to or lower than the gray-scale level of the n-th raw image signal.
